(19) United States
(12) Patent Application Publication
(10) Pub. No.: US 2026/0309568 A1
(43) Pub. Date: Oct. 8, 2026

(54) Roll Over Warning System

(71) Applicant: Total Vehicle Solutions Group Limited, Wisbech (GB)

(72) Inventors: Kevin Walker, Wisbech (GB); John Darren Davies, Buckingham (GB)

(21) Appl. No.: 18/998,490

(22) PCT Filed: Jul. 13, 2023
(86) PCT No.: PCT/GB2023/051848

§ 371 Date: Jan. 25, 2025

(30) Foreign Application Priority Data
Jul. 25, 2022 (GB) 2210872.4

(51) Int. Cl. G01M 1/12; B28C 5/42; B60P 3/16; G01G 19/08

(52) U.S. Cl. CPC G01M 1/122; B28C 5/4224; B60P 3/16; G01G 19/08

(57) ABSTRACT

The present invention relates to a method for alerting an operator of a vehicle (1) for mixing concrete about a potential vehicle roll-over event. The method comprises: determining the centre of gravity (COG2) of a vehicle; determining the forces acting on the vehicle; determining the resultant force vector (R); comparing the determined centre of gravity (COG2) and resultant force vector (R) to known conditions for vehicle rollover; and indicating to an operator of a vehicle the risk of a potential vehicle roll-over event occurring. The present invention also relates to a roll-over warning system (100) configured to perform the method and a vehicle (1), namely a concrete mixer, comprising the roll-over warning system (100).

### FIELD

The present invention relates to a roll over warning system for a vehicle for mixing concrete. The present invention also relates to a method for providing a roll-over warningto an operator of a vehicle for mixing concrete.

### BACKGROUND

Vehicles for mixing concrete are used to transport concrete to a work site whilst mixing the cement and aggregate payload. An operating concern with vehicles for mixing concrete is that roll moments that are generated when the vehicle is turning can cause the vehicle to roll-over. As the vehicle turns, centrifugal force acts on the vehicle in a direction opposite to the direction of the turn. When the vehicle is moving at a speed to high for the radius and camber of the turn, there is a potential that the conditions for vehicle roll-over will be met.

### SUMMARY

According to the present invention, there is provided a method for alerting an operator of a vehicle about a potential vehicle roll over event, the method comprising: determining the centre of gravity of a vehicle; determining the forces acting on the vehicle; determining the resultant force vector ; comparing the determined centre of gravity and resultant force vector to known conditions for vehicle roll over; and indicating to an operator of a vehicle the risk of a potential vehicle roll over event occurring.

In some embodiments, the step of determining the centre of gravity of the vehicle may comprise: determining the centre of gravity of a base vehicle and the centre of gravity of a drum assembly, and determining the presence of a payload and, if a payload is present, determining the centre of gravity of the payload.

In some embodiments, determining the presence of the payload may be performed by an input from an operator.

In some embodiments, determining the presence of the payload may be performed by weighing the drum assembly and calculating the difference between the measured weight and the drum assembly empty weight.

In some embodiments, determining the centre of gravity of the payload may comprise: determining a dead payload position of the centre of gravity of the payload; and determining the rotational velocity of a mixing drum of the drum assembly.

In some embodiments, if it is determined that the mixing drum has a rotational velocity greater than zero, the step of determining the centre of gravity of the payload may comprise: determining the slump value of the payload; determining the climb of the payload based on CFD models; and determining the live load position of the centre of gravity of the payload based on CFD models.

In some embodiments, the step of determining the slump value of the payload may be performed by an input from an operator.

In some embodiments, the step of determining the slump value of the payload may comprise: receiving, from one or more sensors, motor data comprising a state of a motor driving the mixing drum, gearbox data comprising a state of a gearbox arranged between the motor and the mixing drum, and payload data relating to a mass of the payload in the mixing drum; determining, by a machine-learned rotation power model, an initial rotation power of the motor from the motor data; determining, by a gearbox efficiency model, a gearbox efficiency from the gearbox data; determining an adjusted rotation power by adjusting the initial rotation power of the motor of the motor based on the gearbox efficiency; and determining, by a slump prediction model, an estimate slump value of the concrete mix in the mixing drum from the payload data and the adjusted rotation power.

In some embodiments, the step of determining the forces acting on the vehicle may comprise: determining the weight of the payload; determining the weight vector of the vehicle; and receiving, from one or more sensors, data comprising at least one of the lateral forces and the vertical forces acting on the drum assembly.

In some embodiments, the one or more sensors may comprise one or more gyroscopes located proximate to the centreline of the drum assembly and substantially midway along the longitudinal length of the drum assembly.

In some embodiments, the step of determining the resultant force vector may comprise establishing the resultant force vector based on the measured lateral forces, the measured vertical forces and the weight vector of the vehicle.

In some embodiments, the step of comparing the determined centre of gravity and resultant force vector to known conditions for vehicle roll over may comprise: determining known conditions for vehicle roll over by determining a stability vector between the determined centre of gravity and an end of the wheel track; and comparing the direction of the resultant force vector to the direction of the stability vector.

In some embodiments, the step of comparing the direction of the resultant force vector to the direction of the stability vector may comprise the step of determining a roll-over indicator value.

In some embodiments, the step of determining a roll-over indicator value may comprise determining a ratio of the direction of the resultant force vector to the stability vector.

In some embodiments, the roll-over indicator value may be modified based on a sensor configured to determine a future condition.

In some embodiments, the roll-over indicator value may be modified based on a sensor configured to determine the roll-rate of the vehicle.

In some embodiments, the step of indicating to an operator of a vehicle the risk of a potential vehicle roll over event occurring may comprise continuously providing an indication of the risk of a potential vehicle roll-over event to an operator of a vehicle.

In some embodiments, continuously providing an indication of the risk of a potential vehicle roll-over event to an operator of a vehicle may be performed by showing a visual representation of a roll-over indicator value.

In some embodiments, the step of indicating to an operator of a vehicle the risk of a potential vehicle roll over event occurring may be performed visually via a display in a cabin of the vehicle.

In some embodiments, the step of indicating to an operator of a vehicle the risk of a potential vehicle roll over event occurring may be performed audibly via a speaker in a cabin of the vehicle.

In some embodiments, the step of indicating to an operator of a vehicle the risk of a potential vehicle roll over event occurring may comprise alerting an operator of a vehicle about a potential vehicle roll over event is performed when the direction of the resultant vector is within the wheel track and within 30 degrees of the known roll over condition.

In some embodiments, the step of indicating to an operator of a vehicle the risk of a potential vehicle roll over event occurring may comprise alerting an operator of a vehicle about a potential vehicle roll over event is performed when the direction of the resultant vector is within the wheel track and within 10 degrees of the known roll over condition.

In some embodiments, the step of indicating to an operator of a vehicle the risk of a potential vehicle roll over event occurring may comprise alerting an operator of a vehicle about a potential vehicle roll over event is performed when the direction of the resultant vector is in line with the known roll over condition.

According to another aspect of the present invention, there is provided a roll-over warning system comprising: a vehicle comprising a base vehicle and a drum assembly; one or more sensors; one or more processors; a memory; wherein the system is configured to perform the method of any one of claims 1 to 23.

According to yet another aspect of the present invention, there is provided a vehicle comprising the roll-over warning system of claim 24. In some embodiment, the vehicle may be a concreter mixer.

### BRIEF DESCRIPTION OF DRAWINGS

Embodiments of the invention will now be described, by way of example only, with reference to the accompanying drawings, in which:

FIG. 1 shows a perspective side view of a vehicle for mixing concrete;

FIG. 2 shows a schematic rear view of a vehicle for mixing concrete including a load at rest and during rotation;

FIG. 3 shows a schematic flow diagram representing a method of alerting an operator about a potential vehicle roll-over event;

FIG. 4 shows a schematic flow diagram representing the method steps for determining a centre of gravity of a vehicle;

FIG. 5 shows a schematic diagram of a roll-over warning system;

FIG. 6 shows a schematic overview of an example method of measuring the slump of a payload;

FIG. 7 shows a flow diagram of an example method of measuring the slump of a payload;

FIG. 8 shows a schematic overview of a method for monitoring a mixing drum of a vehicle; and

FIG. 9 shows a schematic flow diagram representing the method steps for measuring the forces acting on a vehicle; and

FIG. 10 shows a schematic flow diagram representing the method steps for comparing the determined centre of gravity and resultant force vector to known conditions for vehicle roll over.

### DETAILED DESCRIPTION

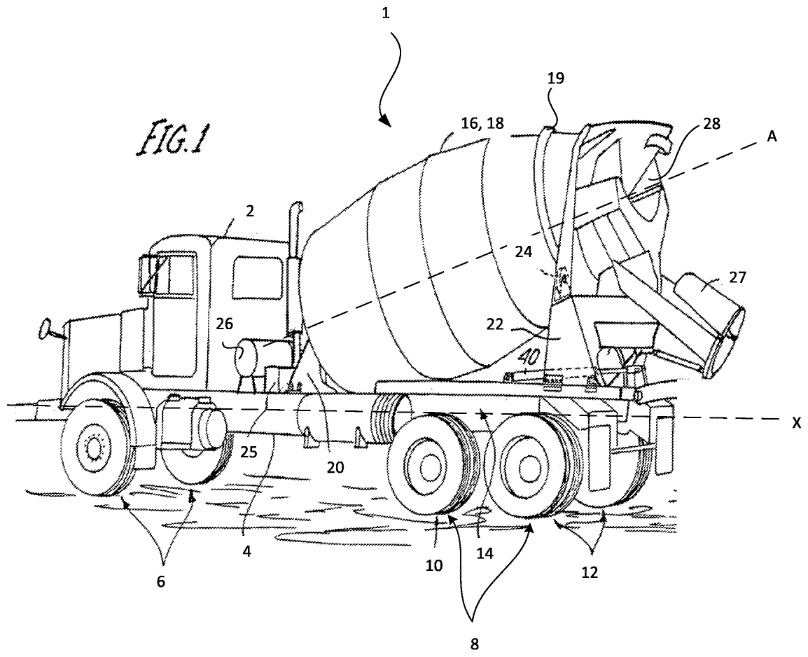

Referring to FIG. 1, a side perspective view of a vehicle 1 for mixing concrete is shown. The vehicle 1 is a concrete mixing truck. The vehicle 1 comprises a cabin 2 and a chassis 4. The vehicle 1 typically has three set of wheels. A first set of wheels 6 may be located at the cabin 2, and a tandem set of wheels 8 may be located on the chassis 4. The tandem set of wheels 8 may comprise a front truck set of wheels 10 and a rear truck set of wheels 12.

The chassis 4 may comprise a frame 14. The frame 14 forms a base onto which further features of the vehicle 1 can be mounted. The frame 14 extends generally horizontally such that its longitudinal axis X extends substantially parallel to the ground. The plane that extends vertically from the longitudinal axis X that extends along the centre of the vehicle 1 may be referred to as the centreline Y of the vehicle 1. The vehicle 1 further comprises a mixing drum 16. The mixing drum 16 is configured to hold and mix concrete. The mixing drum 16 is configured to mix a payload 17 by rotating about its central longitudinal axis A, as will be described in more detail hereinafter. In the present embodiment, the payload 17 is concrete.

The mixing drum 16 comprises an outer skin 18 and a drum 19. The drum ring 19 extends about the circumference of an outer surface of the outer skin 18 of the mixing drum 16. The plane in which the drum ring 19 extends is substantially perpendicular to the central longitudinal axis A of the mixing drum 16. The drum ring 19 may be stronger than the drum skin 18. The drum ring 19 may be formed from, for example, but not limited to, a ring of hard steel.

The mixing drum 16 is supported by the frame 14 of the chassis 4. The chassis 4 comprises a first pedestal 20 located at the front of the frame 14, also known as a front support, and a second pedestal 22, located at the rear of the frame 14, also known as a rear support stool. The mixing drum 16 is supported by the first and second pedestals 20, 22 and allowed to rotate relative thereto.

As shown in FIG. 1, the second pedestal 22 extends further from the frame 14 than the first pedestal 20. Therefore, the second pedestal 22 at the rear of the frame 14 has a greater height than the first pedestal 20 at the front of the frame 14. The difference in height of the first and second pedestal 20, 22 allows the rear of the mixing drum 16 to be supported at an elevated height compared to the front of the mixing drum 16. That is, the central longitudinal axis A of the mixing drum 16 is inclined relative to the longitudinal axis X of the frame 14 of the chassis 4.

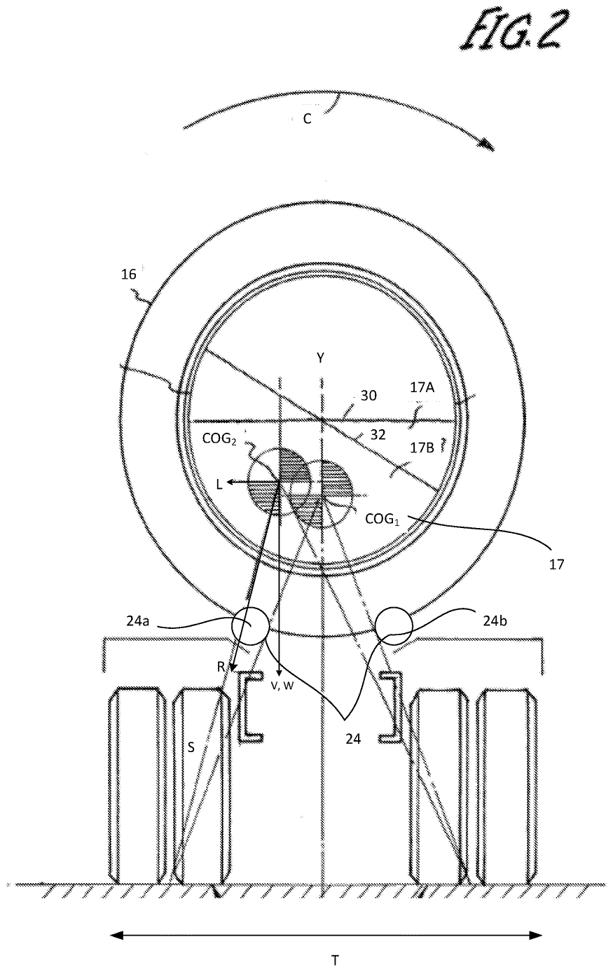

The chassis 4 further comprises a pair of drum rollers 24. The pair of drum rollers 24 comprises a port side roller 24a and a starboard side roller 24b, shown in FIG. 2, which are located on opposing sides of a centreline Y of the vehicle 1. In the present embodiment, the drum rollers 24a, 24b are attached to the rear pedestal 22, or rear support stool. The drum rollers 24a, 24b engage a rear part of the mixing drum 16. In the present embodiment, the drum rollers 24a, 24b engage the drum ring 19. The drum rollers 24 support the mixing drum 16 on the rear pedestal 22 and allow rotation of the mixing drum 16 about its central longitudinal axis A.

The first pedestal 20 of the vehicle 1 may further comprise a gearbox 25, which controls rotation of the mixing drum 16 to mix the concrete. The gearbox 25 may be configured to allow rotation of the mixing drum 16 about three orthogonal axes. Thus, the mixing drum 16 can pivot about the first pedestal 20 in any direction. The vehicle 1 may further comprise a drum motor 26. The drum motor 26 may be configured to provide the rotational force to rotate the mixing drum 16. The drum motor 26 can be powered by an electric motor, by a hydraulic motor, or by the engine of the vehicle 1. The gearbox 25 may connect the drum motor 26 to the mixing drum 16 to transmit and convert the power supplied by the drum motor 26 to the correct rotational speed of the mixing drum 16.

The vehicle 1 may further comprise a chute 27, which is located proximate to a discharge opening 28 of the mixing drum 16, such that the payload 17 can be delivered via the chute 27 from the mixing drum 16 to a worksite.

Due to the elevated height at which the rear of the mixing drum 16 is supported by the rear pedestal 22 compared to the front of the mixing drum 16 on the front pedestal 20, or inclined angle between the frame 14 and the central longitudinal axis A of the mixing drum 16, the discharge opening 28 of the mixing drum 16 is elevated. This enables the mixing drum 16 to carry a larger payload 17 without spilling the payload 17 out of the discharge opening 28.

Referring now to FIG. 2, it can be seen that the larger the payload 17 within the mixing drum 16, enabled by the inclination of the rear of the mixing drum 16 relative to the frame 14, raises the centre of gravity of the mixing drum 16 and its payload 17. Therefore, when the mixing drum 16 is not rotating the centre of gravity, shown by the label COG₁ in FIG. 2, of the mixing drum 16 and the payload 17 is centred relative to the centreline Y, or the longitudinal axis X, of the vehicle 1. In FIG. 2, the centre of gravity COG₁ of the mixing drum 16 and the payload 17 is shown as being higher than the pair of drum rollers 24 with respect to the frame 14. However, it will be understood that this is merely for illustration purposes, and that in most, but not necessarily all, cases, the centre of gravity COG₁ of the mixing drum 16 and its payload 17 may be below or at least in line with the position of the pair of drum rollers 24.

When the payload 17 is not being rotated it is in what is known as a dead payload position 17A. When in the dead payload position 17A, an upper surface 30 of the payload 17 is substantially level, i.e. horizontal. The height of the centre of gravity COG₁ of the dead payload 17 is determined by the volume and density of the payload 17 within the mixing drum 16. Furthermore, the centre of gravity COG₁ of the mixing drum 16 and the payload 17 is vertically in line with the rotational axis A of the mixing drum 16 when there are no lateral forces of the mixing drum 16 due to the vehicle 1 turning.

To mix the payload 17 in the mixing drum 16, the mixing drum 16 is rotated about its longitudinal axis A. The mixing drum 16 may be rotated clockwise as shown in FIG. 2 by arrow C when viewed from the rear of the vehicle 1, i.e. the opposite end of the vehicle 1 to the cabin 2. Thus, the following description relates to forces and centre of gravity in relation to clockwise rotation of the mixing drum 16. However, it will be appreciated that the mixing drum 16 may alternatively be rotated anti-clockwise and that all the forces and positioning of the centre of gravity may be opposite to the description given below.

As the mixing drum 16 rotates in the clockwise direction C, the payload 17 is caused to move by the motion of the mixing drum 16. The payload 17 rises, or shifts laterally, up the port side of the inner surface of the mixing drum 16. The leftwards lateral shift of the payload 17 also causes the payload 17 to rise up the inner surface of the mixing drum 16, which causes the centre of gravity, shown by label COG₂ in FIG. 2, to move upwards and to the left of the centreline Y of the vehicle 1, when viewed from the rear of the vehicle 1.

When the payload 17 is being rotated it is in what is known as a live payload position 17B. The live payload position 17B and the payload's centre of gravity COG₂ is determined by the volume, density, and viscosity of the payload 17 and the rotational velocity of the mixing drum 16. The live payload position 17B and the payload's centre of gravity COG₂ is also affected by the movement of an internal screw (not shown in the drawings) within the mixing drum 16. Different configurations of the internal screw, such as radius and pitch will affect the extent to which the payload is mixed and/or lifted up the internal surface of the mixing drum 16. These factors will further affect the live payload position 17B and the payload's centre of gravity COG₂. When in the live payload position 17B, an upper surface 32 of the payload 17 is inclined with respect to the horizontal or dead payload position 17A. A part of the upper surface 32 of the payload 17 in the live payload position 17B may be above the location of the upper surface 30 of the payload 17 when the payload 17 is in the dead payload position 17A, as shown in FIG. 2. Furthermore, a part of the upper surface 32 of the payload 17 in the live payload position 17B may be below the location of the upper surface 30 of the payload 17 when the payload 17 is in the dead payload position 17A, as shown in FIG. 2.

The movement of the centre of gravity COG of the payload 17 away from the centreline Y of the vehicle 1 and vertically upwards during rotation of the mixing drum 16 further narrows the operating window of the vehicle 1 before the vehicle 1 begins to roll-over and/or the mixing drum 16 becomes unseated from the pair of rollers 24, i.e. enters an off-centre position and/or conditions for roll-over are met.

More specifically, the raising and movement of the centre of gravity away from the centreline Y of the vehicle 1 means that less centrifugal, or lateral, force is required for roll-over conditions of the vehicle 1 to be met. Once the lateral force due to turning, based on corner radius and camber, and vehicle velocity, is sufficient for the vehicle 1 to become unstable, the vehicle 1 will begin to roll. If the vehicle 1 does not become stable shortly thereafter, the vehicle 1 will continue to roll until it rolls over completely.

The aim of the present invention, as outlined below, is to provide a system that provides an indicator of the risk of a roll over event to an operator of a vehicle 1. The system may provide an indicator of the risk of a roll over event at all times or only when the conditions of roll over are almost met, i.e. exceed a predetermined threshold. The method detailed below enables an operator of a vehicle 1 to be alerted of an impending roll-over event using measurements based independent of the chassis 4 of the vehicle 1.

Referring to FIG. 1, a schematic block diagram is shown representing a method for alerting an operator of a vehicle 1 about a potential vehicle roll-over event. The method comprises: determining the centre of gravity of a vehicle (S1); determining the forces acting on the vehicle (S2); determining the resultant force vector (S3); comparing the determined centre of gravity and resultant force vector to known conditions for vehicle roll-over (S4); and alerting an operator of a vehicle about a potential roll-over event when the centre of gravity and the resultant force vector are within a predetermined threshold of a known roll-over condition.

It is known that a vehicle 1 will remain stable whilst the resultant force vector acting on it is within its wheel track T, shown in FIG. 2, or within the extremities of its contact patches with the ground. Therefore, when the resultant force vector acts outside of the wheel track T, a vehicle 1 is likely to become unstable. For a vehicle 1, such as a concrete mixer, this problem is compounded by the movement of the centre of gravity COG of the payload 17 during transit. Furthermore, in an effort to extend the range over which such vehicles 1 can deliver a payload, the operators are required to drive the vehicles 1 faster. Driving the vehicles 1 faster can cause spillage of the payload 17. Therefore, the screw (not shown) in the mixing drum 16 is operated to drive the payload 17 forward into the mixing drum 16 to prevent spillage. However, this causes the payload 17 to climb the inner surface of the mixing drum 16, as described above. Further environmental factors can have an effect on the stability of the vehicle 1, including side wind effect.

In addition to these issues, the attitude of the vehicle 1 can play a significant role in whether the resultant force vector remains within the wheel track T. For example, when the vehicle 1 is on a cambered road, the gravitational forces no longer act perpendicularly to the wheel track T. Therefore, the attitude, or roll angle, of the vehicle 1 relative to the horizontal plane significantly impacts the initial stability of the vehicle 1. The larger the camber angle of the road, the larger the roll angle of the vehicle 1 and the closer the resultant force vector is to the end of the wheel track T before lateral forces are considered. This means that a vehicle 1 travelling along a cambered road is already closer to a roll-over event than a vehicle travelling along a non-cambered, flat road.

The present invention relates to a roll-over warning system 100 for alerting an operator of a vehicle 1 about the level of risk of a potential roll-over event occurring. The roll-over warning system 100 comprises a vehicle 1 comprising a base vehicle 101 and a drum assembly 102. The roll-over warning system 100 further comprises one or more sensors 110. The one or more sensors 110 are configured to measure one or more parameters of the roll-over warning system 100, as will be explained in more detail hereinafter. The one or more sensors 110 may be configured to detect or measure parameters of the roll-over warning system 100. The parameters of the roll-over warning system 100 may include, but are not limited to, the presence and/or weight of the payload 17, the centre of gravity of the payload 17, the rotational velocity of the mixing drum 16, camber of the road being travelled on, and the forces acting on the drum assembly 102. In some embodiment, the roll-over warning system 100 may comprises a user interface 111. The user interface 111 may be configured to allow an operator to input values. In some embodiments, the roll-over warning system 100 may comprise a receiver 112. The receiver 112 may be configured to receive signals carrying data relating to one or more parameters of the roll-over warning system 100 from an external transmitter (not shown).

The roll-over warning system 100 may further comprises one or processors 114. The one or more processors 114 may be configured to determine parameters of the roll-over warning system 100 based on the values measured or detected by the one or more sensors 110. The parameters of the roll-over warning system 100 may include, but are not limited to, the weight of the payload 17, the centre of gravity of the payload 17, the camber of the road the vehicle 1 is traveling on, the resultant force vector of the forces acting on the drum assembly 102, roll-over conditions, and the stability state of the vehicle 1. The roll-over warning system 100 may further comprise a memory 116. The memory 116 may be configured to store one or more parameters of the roll-over warning system 100 determined by the one or more processors 114 or measured or detected by the one or more sensors 110. The roll-over warning system 100 may be configured to perform the method outlined below to alert an operating of the vehicle 1 about a potential roll-over event.

The first step (S1) of the method comprises determining the centre of gravity of the vehicle 1. The centre of gravity of the vehicle 1 and/or the centre of gravity of components of the vehicle 1 may be determined in a predetermined reference frame. The predetermined reference frame may have a coordinate system that has its origin at ground level and on the centreline of the vehicle 1. Such a reference frame is sufficient for a system that is concerned with the centre of gravity in two dimensions, i.e. the height of the centre of gravity and the distance in the horizontal direction of the centre of gravity from the centre line of the vehicle 1. In instances where the system is concerned with the centre of gravity in three dimensions, the original of the coordinate system may be located at any point along the longitudinal length of the vehicle 1.

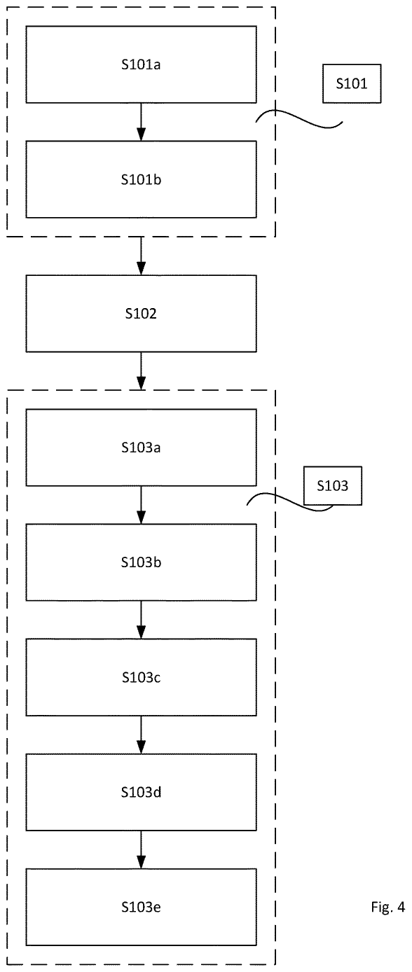

As shown in FIG. 4, determining the centre of gravity of the vehicle 1 comprises determining the centre of gravity of a base vehicle 101 (S101a). The base vehicle 101 is formed by the cabin 2, chassis 4, and wheels 6, 8 of the vehicle 1. Determining the centre of gravity of the vehicle 1 further comprises determining the centre of gravity of the drum assembly 102 (S101b). The drum assembly 102 is formed by the mixing drum 16 and the front and rear pedestals 20, 22.

In some embodiments, the centre of gravity COG of the base vehicle 101 and the drum assembly 102 can be determined from the manufacturer's data. The centre of gravity COG of the base vehicle 101 and the drum assembly 102 can be determined as a single mass (S101) or separately (S101a, S101b) and then the overall centre of gravity COG of the vehicle 1 determined from the individual values. In some embodiments, the centre of gravity COG of the base vehicle 101 and the drum assembly 102 can be determined using a tilt table.

Determining the centre of gravity of the vehicle 1 further comprises determining the presence of a payload 17 (S102). The step of determining the presence of a payload 17 can be performed in a number of different ways. One option is for the presence of the payload 17 to be determined via an input from an operator. The operator may be the driver of the vehicle 1 or a worker at the batching plant. For example, when the vehicle 1 is at the batching plant, a worker may input into the roll-over warning system 100 via a user interface 111 whether a payload 17 has been loaded into the mixing drum 16. Another option for determining the presence of the payload 17 is via a batching plant system. The batching plant system may be an automated system. The batching plant system may determine whether a payload 17 has been loaded into the mixing drum 16 of the vehicle 1 and send a signal to the receiver of the roll-over warning system 100 to indicate whether a payload 17 is present.

Another option for determining the presence of a payload 17 (S102) is to weigh the drum assembly 102. That is, determining the presence of the payload 17 can be performed by weighing the drum assembly 102 and calculating the difference between the measured weight and the drum assembly empty weight.

In some embodiments, the weight of the drum assembly 102 without a payload 17 can be stored in the memory 116 of the roll-over warning system 100. The drum assembly 102 may weighed. The drum assembly weight 102 may be measured by at least one sensor 110. The at least one sensor 110 may be, for example, but not limited to a pressure sensor or scale, such as a load cell. In some embodiments, there may be a plurality of sensors 110 configured to measure the weight of the drum assembly 102. The plurality of sensors 110 may comprise a front load cell and a rear load cell. The front load cell may be located under the first pedestal 20. The rear load cell may be located under the second pedestal 22. That is, the front load cell may be located between the first pedestal 20 and the frame 14 of the chassis 4. The rear load cell may be located between the rear pedestal 22 and the frame 14 of the chassis 4. It will be appreciated that in an alternative embodiment, the at least one sensor 110 may be located such that it measures the weight of substantially only the mixing drum 16 and any payload 17 in the mixing drum 16.

In an alternative embodiment, and especially in the case where a vehicle 1 is retro fitted with the presently described roll-over warning system 100, the load cells may be located on the suspension of the vehicle 1 or in the truck air bag system.

The at least one sensor 110 may send data related to the measured drum assembly weight to the at least one processor 114. The at least one processor 114 may be configured to compare the measured drum assembly weight to the empty weight of the drum assembly 102 stored in the memory 116. If the weight of the drum assembly 102 is greater than the drum assembly empty weight then the processor 114 can determine that there is a payload 17 present.

In some embodiments, the presence of a payload 17 may be determined by weighing the drum assembly 102 at time intervals. The time intervals may be predetermined lengths of time. Alternatively or additionally, the time intervals may be based on the location of the vehicle 1. For example, the roll over warning system 100 may determine based on, for example, GPS data that it is about to enter a batching plant, or a loading dock, and weigh the drum assembly 102. Subsequently, the roll-over warning system 100 may weigh the drum assembly 102 when the vehicle 1 is about to leave the batching plant, or loading dock.

In this instance, the drum assembly empty weight may be considered to be the weight of the drum assembly 102 when the vehicle 1 enters a batching plant, or loading dock. Furthermore, the measured weight may be considered to be the weight of the drum assembly 102 when the vehicle 1 leaves the batching plant, or loading dock. The drum assembly empty weight measured on entering the batching plant, or loading dock, may be stored in the memory 116 of the roll-over warning system 100. The measured weight measured on leaving the batching plant, or loading dock, may then be compared to the drum assembly empty weight. If the weight of the drum assembly 102 is greater than the drum assembly empty weight then the processor 114 can determine that there is a payload 17 present.

In addition to or in determining whether a payload 17 is present, the method may comprise determining the weight of the payload 17. Determining the weight of the payload 17 can be performed in a number of ways. The worker may input into the roll-over warning system 100, via the user interface 111, the weight of the payload 17 loaded into the mixing drum 16. Alternatively, a delivery apparatus at the batching plant, or loading dock thereof, may comprise a sensor (not shown) configured to measure the amount of payload 17 dispensed from the batching plant into the mixing drum 16 of the vehicle 1.

The sensor may determine the weight of the payload 17 loaded into the mixing drum 16 or may determine the mass or volume of the payload 17 loaded. A processor may determine the weight of the payload 17 based on the mass of the payload 17 dispensed from the batching plant, or the mass flow rate of the payload 17 dispensed, or from the volume of the payload 17 dispensed. The processor may need to know the slump type of the payload 17 dispensed to determine the weight of the payload 17 based on the mass flow rate or volume of the payload 17 dispensed from the batching plant. This information can be provided by the batching plant system or via a user input into the batching plant system.

The processor of the batching plant system may send the determined weight of the payload 17 loaded into the mixing drum 16 to a transmitter (not shown) of the batching plant system. The transmitter may be configured to send a signal with the determined weight of the payload 17 to a receiver of the roll-over warning system 100. The receiver 112 of the roll-over warning system 100 may be configured to pass on the information relating to the one or more parameters to the one or more processors 114.

In an alternative embodiment, the batching plant system may send the raw data relating to the mass, mass flow rate, volume, and/or slump type of the payload 17 loaded into the mixing drum 16 to the receiver 112 of the roll-over warning system 100, and the one or more processors 114 of the roll-over warning system 100 may determine the weight of the payload 17.

The step of determining the centre of gravity of the vehicle 1 (S1) may further comprise determining, when present, the centre of gravity of the payload (S103). The step of determining the centre of gravity of the payload 17 (S103) comprises determining a dead payload position 17A of the centre of gravity of the payload (S103a). As described above, the dead payload position 17A is the centre of gravity COG₁ that the payload 17 would have when the mixing drum 16 is not rotating. The system 100 may determine the dead payload position 17A for a vehicle 1 on a flat road without camber and then adjust the dead payload position in dependence from an input from the camber sensor 110 regarding the current camber, or roll-angle, of the vehicle 1. The dead payload position 17A may be a theoretical dead payload position 17A considering that the mixing drum 16 may be rotating. Therefore, a would be or theoretical dead payload position 17A is determined regardless of the rotational state of the mixing drum 16. In some embodiment, the system 100 may determine the dead payload position 17A of the vehicle 1 on a cambered road based on the weight of the payload 17 and the known camber angle.

In some embodiments, the centre of gravity COG₁ of the dead payload position 17A of the payload 17 can be determined based on the geometry of the inside of the mixing drum 16, the weight and/or volume of the payload 17 being carried, and the camber of the road the vehicle 1 is on. As mentioned above, the weight of the payload 17 may be determined based on input from an operator or a sensor that is a part of the batching plant system, or by determining the weight of the payload 17, and the volume of the payload 17 may be determined based on input from an operator or a sensor that is a part of batching plant system.

The step of determining the centre of gravity of the payload (S103) may further comprise determining the rotational velocity of the mixing drum 16 of the drum assembly 102 (S103b). The rotational velocity of the mixing drum 16 may be determined from motor data from the drum motor 26 of the vehicle 1. The motor data may be received by the at least one processor 114 from one or more sensors 110 of the drum motor 26. The at least one processor 114 of the roll-over warning system 100 determines whether the mixing drum 16 of the drum assembly 102 has a rotational velocity grater then zero.

If it is determined that the mixing drum 16 has a rotational velocity greater than zero, then the viscosity of the payload 17 will cause the payload 17 to climb the inner surface of the mixing drum 16. Thus, as described above, the payload 17 will move into its live payload position 17B and the centre of gravity COG₂ of the payload 17 will shift laterally away from the centreline Y of the vehicle 1, i.e. closer to the extremity of the wheel track T.

If it is determined that the mixing drum 16 has a rotational velocity greater than zero, the step of determining the centre of gravity COG of the payload 17 comprises determining a slump value of a payload 17 (S103c). The step of determining the slump value of the payload 17 (S103c) can be performed in a number of different ways.

In some embodiments, the step of determining the slump value of the payload 17 (S103c) is performed by input from an operator. The operator may be the driver of the vehicle 1 or a worker at the batching plant. For example, when the vehicle 1 is at the batching plant, a worker may input into the roll-over warning system 100 via the user interface 111 the slump value of the payload 17 being added to the mixing drum 16 of the vehicle 1.

In some embodiments, the step of determining the slump value of the payload 17 is performed by the batching plant system. The batching plant system may determine the slump value of the payload 17 loaded into the mixing drum 16 of the vehicle 1. The batching plant system may know the slump type of the payload 17 based on the loading dock the payload 17 is taken from or the concrete bin that the payload 17 is taken from. The batching plant system may send a signal to the receiver of the roll-over warning system to indicate the slump value of the payload 17 loaded into the mixing drum 16 of the vehicle 1.

In some embodiments, the method of determining the slump value of the payload 17 may comprise receiving, from one or more sensors 110, motor data comprising a state of a motor driving the mixing drum 16, gearbox data comprising a state of a gearbox 25 arranged between the motor 26 and the mixing drum 16, and payload data relating to a mass of the payload 17, or concrete mix, in the mixing drum 16. The method of determining the slump value of the payload 17 may further comprise determining, by a machine-learned rotation power model, an initial rotation power of the motor from the motor data. The method of determining the slump value of the payload 17 may further comprise determining, by a gearbox efficiency model, a gearbox efficiency from the gearbox data. The method of determining the slump value of the payload 17 may further comprises, determining, by a slump prediction model, and estimate slump value of the payload 17, or concrete mix, in the mixing drum 16 from the payload data and the adjusted rotation power.

The method of determining the slump value of the payload 17 is based on the use of a machine-learned model to estimate the rotation power of a motor 26 rotating the drum of a concrete mixer. The rotation power determined by the machine-learned model is then used to assess the slump value of the payload, which is a concrete mix, in the mixing drum 16 using a slump-power model, which is also referred to herein as a “slump prediction model”. Since the rotation power of a motor is a complex function of the power supplied to the motor, the motor temperature and the rotation speed, the use of a machine-learned model can simplify the determination of the rotation power, while also increasing the accuracy of the determined rotation power, and consequently the slump value measurement.

As mentioned above, the motor 26 is coupled to the mixing drum 16 via the gearbox 25. The motor 26 applies torque to the mixing rum 16 via the gearbox 25 in order to rotate the mixing drum 16. The motor 26 may be a bi-directional drive motor, i.e. capable of rotating the mixing drum 16 both clockwise and anti-clockwise around the central axis. The motor 26 may be a hydraulic motor or an electric motor.

The roll-over warning system may further comprise a plurality of sensors 110A-D configured to measure properties of the system 100 and/or the payload 17.

The plurality of sensors may comprise one or more load sensors 110A. The load sensors 110A are configured to measure the load of the payload 17, e.g. the mass of the mixing drum 16 plus the mass of the payload 17 in the mixing drum 16. In some embodiments, the one or more load sensors comprise at least two load sensors 110A: a front load sensor arranged to measure the load at the front of the mixing drum (i.e. the end furthest from the mouth of the mixing drum 16 or front pedestal 20); and a rear load sensor arranged to measure the load at the rear of the mixing drum 16 (i.e. the end closest to the mixing drum 16 mouth or rear pedestal 22). The load sensors 110A may be zeroed prior to the concrete mix being loaded to account for the build up of dried concrete in the mixing drum 16.

The plurality of sensors may further comprise a mixing drum temperature sensor 110B configured to measure the temperature of the mixing drum 16 or the payload 17, i.e. concrete, in the mixing drum 16 directly. The temperature can be a contact temperature (either internal or external to the mixing drum 16) or a non-contact temperature measurement. The temperature of the payload 17, i.e. concrete mix, can be an important factor in determining the slump value of the payload 17, i.e. concrete, since the temperature affects the evaporation rate of moisture in the concrete mix.

The plurality of sensors may further comprise one or more (e.g. a plurality) of motor state sensors 110C configured to measure the state of the motor 26, e.g. the current/voltage supplied to the motor 26 for an electric motor, the input and output hydraulic pressures for a hydraulic motor, the motor temperature, the hydraulic fluid temperature and/or the motor rotation speed. The motor state sensors 110C may further comprise a mixing drum speed sensor, such as an optical encoder or magnetic sensor, though this may alternatively be fitted to the mixing drum 16 itself, when present.

The plurality of sensors may further comprise one or more (e.g. a plurality) of gearbox state sensors 110D configured to measure the state of the gearbox 25, e.g. the input torque/rotation speed to the gearbox 25, the gearbox temperature, the gearbox fluid level, or the like. Each of the gearbox state sensors 110E may be fitted to the gearbox 25 directly, or to some other part of the system, e.g. the motor 25 for an input torque sensor.

It will be appreciated that there are multiple possible sensors or combinations of sensors that can be arranged to measure the variables required for the methods used herein. As an example, the input torque may be determined using a direct torque measurement via torque sensor on the drive system. Alternatively, the torque can be derived indirectly from other measurements of the motor, such as input current, input and output hydraulic pressures or the like. As another example, the drum speed may be determined from the motor speed and the gearbox ratio, or alternatively measured directly.

The sensors may be connected to an electronic control unit (ECU, not shown) of the vehicle 1, i.e. concrete mixer. The ECU may use the sensor data to determine properties of the system 100, and to control the other elements of the system.

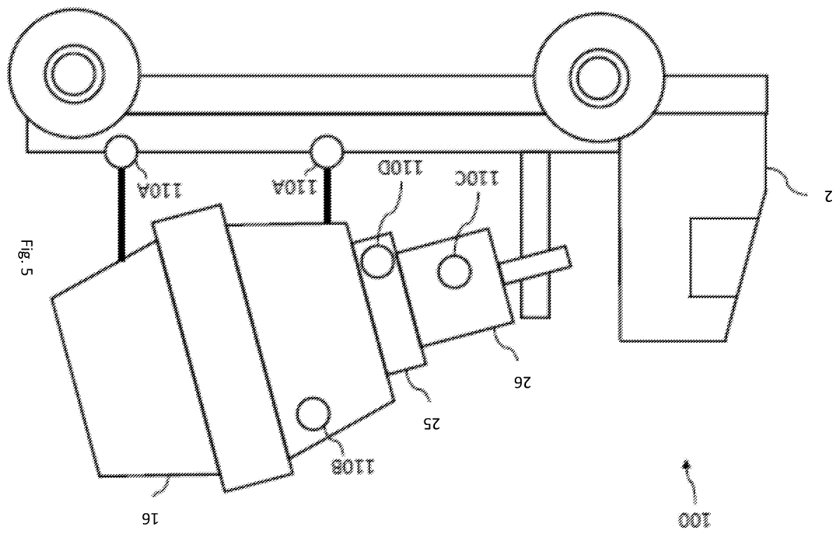

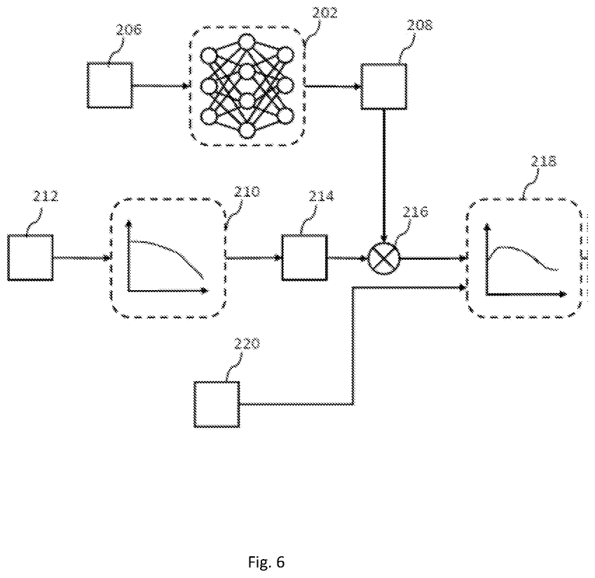

FIG. 6 shows a schematic overview of the method of determining the slump value of the payload 17 (S103c). The method may be implemented by one or more computing devices. The computing devices may form part of the system shown in FIG. 5, for example that are part of an electronic control unit (ECU) of the vehicle 1. The method uses a plurality of models 202, 210, 218 to estimate the slump from sensor data obtained from the system.

A machine-learned rotation power model 202 (also referred to herein as a “first machine-learned model”) takes as input data 206 relating to a state of a motor driving a mixing drum 16 of a vehicle 1 (also refer to herein as “motor data”) and processes it to determine an initial estimate of the rotation power 208 of the motor 26 (also referred to herein as an “initial rotation power”). In general, drum rotation power is a complex calculation relying on more than just hydraulic pressure/power supplied to the motor 26 and drum speed. Changes in hydraulic or electric motor temperature can lead to significant differences in power requirements, which are hard to account for using physical models. The use of a machine learned model allows for fast and accurate determination of the rotation power without recourse to the approximations used in physical models.

The motor data 206 may comprise a motor speed, e.g. the current rotational speed of the motor 26, and/or a payload 17. Where the motor 26 is an electric motor, the motor data 206A may further comprise a current and/or a voltage supplied to the motor 26, and a motor temperature. Where the motor 26 is a hydraulic motor, the motor data 206A may further comprise an input hydraulic pressure and/or an output hydraulic pressure supplied to the motor 26, and a hydraulic fluid temperature.

The machine-learned rotation power model 202 may comprise a neural network model. A neural network comprises a plurality of neural network layers, each comprising a plurality of nodes. Each node takes one or more inputs, and determines a node activation value based on a weighted sum of its inputs, where the weights of the sum are learned parameters of the neural network. A non-linear activation function, such as a sigmoid function or ReLu function, is applied to the weighted sum to determine the activation value for the node. Nodes in an input layer of the neural network take as input the input data to the network, with nodes in subsequent layers taking as input one or more outputs from a previous layer. A final layer of the network, known as the output layer provides the neural network output. Layers between the final layer and input layer are referred to as hidden layers.

In some embodiments, the neural network may be a fully connected neural network. A fully connected neural network is a network in which each node in a hidden layer or the final layer takes as input the activation value of every node in the preceding layer. The neural network may, for example, be a relatively shallow neural network, comprising an input layer, and output layer and one or two hidden layers. The neural network may alternatively be a convolutional neural network (CMM) or a recurrent neural network (RNN).

Other types of machine-learned model may alternatively be used. These include, but are not limited to, regression models, support vector machines, genetic models or the like.

A gearbox efficiency model 210 is used to estimate a gearbox efficiency 214 that is used to adjust the initial rotation power to determine an adjusted estimate of the drum rotation power. The gearbox efficiency model 210 takes as input data 212 relating to the state of a gearbox coupling the motor 26 to the mixing drum 16 of a vehicle 1 (also referred to herein as “gearbox data”) and determine an efficiency 214 of the gearbox 25. The gearbox data 212 may comprise an input torque to the gearbox 25. The gearbox data 212 may further comprise a gearbox temperature and/or a gearbox fluid level. The gearbox data 212 may comprise a drum speed.

The gearbox efficiency model 210 may be a parametrised curve derived from a physical model or real-world data. Alternatively, the gearbox efficiency model 210 may be a look-up table. Alternatively, the gearbox efficiency model 210 may be a machine-learned model, such as a neural network, as described above in relation to the machine-learned rotation power model 202.

The output of the machine-learned rotation power model 202 (i.e., the rotation power 208 of the motor) and gearbox efficiency model 210 (i.e., the gearbox efficiency 214) may be combined 216 to generate an estimated rotation power value, i.e., the initial rotation power 208 estimated by the machine-learned rotation power model 202 is adjusted based on the gearbox efficiency 214. For example, the initial rotation power 208 may be multiplied by the gearbox efficiency 214 to obtain the rotation power supplied to the drum.

A slump prediction model 218 is used to estimate the slump 204 of the payload 17, i.e. concrete mix, from the adjusted rotation power and further input data 220. The further input data may comprise a payload or concrete mix temperature and or a payload or concrete mix mass (i.e. the load of the mixing drum 16). The further input data may also comprise a drum rotation speed. The power required to rotate the mixing drum 16 at a constant speed is a function of slump, volume/mass, and mixing drum geometry, which is captured by the slump prediction model. In some embodiments, the slump prediction model may be drum geometry specific, i.e. each model may have been derived from a mixing drum 16 or a simulation of a mixing drum 16 with a particular drum geometry, e.g. length, internal/external diameter, internal protrusions, etc.

The slump prediction model 218 may be a parametrised curve derived from a physical model or real-world data. Alternatively, the slump prediction model 218 may be a look-up table. Alternatively, the slump prediction model 218 may be a machine-learned model, such as a neural network, as described above in relation to the machine-learned rotation power model 202.

In some embodiments, a drum zeroing procedure is used to establish the power requirements for rotating an empty drum and to zero the load cells (i.e. the mass sensors) on the drum. This procedure may involve: a) ensuring drum is empty; and then b) rotating drum at a plurality of (constant) speeds and assessing the power required using the machine-learned rotation power model 202. The result is a rotation profile of the empty drum. The zero weight and power data may be stored and used for future calculations. A baseline rotation profile comprising a rotation profile of a drum when new and empty may also be stored as a reference for a new machine.

The first baseline zeroing may be carried out in the factory, and can be stored permanently in the ECU of the concrete mixer. Zeroing may be repeated at intervals during the drum service life (e.g. every 3 months or 6 months) to ensure the system operation is consistent with baseline readings, and to assess drum build up (i.e. concrete deposited to wall of drum).

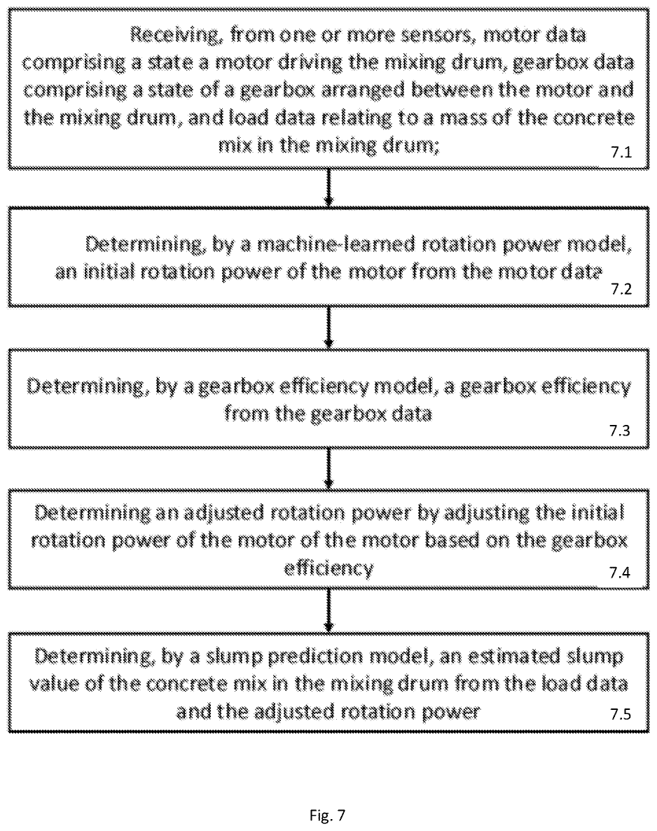

FIG. 7 shows a flow diagram of an example method for estimating the slump value of a payload 17, i.e. concrete mix, in a vehicle 1, i.e. a concrete mixer. The method may be performed by a computing device, such as an ECU of a vehicle 1, i.e. a concrete mixer.

In some embodiments, prior to the method being performed, a zeroing procedure is undertaken. The zero procedure comprises, for each of a plurality of drum rotation speeds: rotating the mixing drum without the concrete mix present; and determine, using the machine-learned rotation power model, a rotation power for the mixing drum at the rotation speed. A rotation profile for the empty drum is determined based on the on the respective determined rotation powers for each rotation speed. The empty drum rotation profile may be compared to a baseline rotation profile, e.g. a rotation profile of the drum when new, to assess drum build up.

At operation 7.1, motor data comprising a state a motor driving a mixing drum, gearbox data comprising a state of a gearbox arranged between the motor and the mixing drum, and load data relating to a mass of the concrete mix in the mixing drum are received from a set of sensors coupled to the concrete mixer.

In some embodiments, the motor is an electric motor. In such embodiments, the motor data may comprise: a motor speed; an electrical current and/or electrical voltage supplied to the electric motor; and a temperature of the electric motor.

Alternatively, the electric motor may be a hydraulic motor. In such embodiments, the motor data may comprise: a motor speed; an input hydraulic fluid pressure; an output hydraulic fluid pressure; and a hydraulic fluid temperature.

The gearbox data may comprise: an input torque to the gearbox; a motor or drum speed; a gearbox temperature; and a gearbox fluid level.

The load data may comprise a combined mass of the mixing drum and concrete mix. Alternatively, where a zeroing or calibration procedure is used, the load data may be the mass of the concrete mix, for example obtained by subtracting a known mass of the drum (including any concrete build-up) from the combined mass of the drum and the concrete mix.

At operation 7.2, an initial rotation power of the motor is determined from the motor data by a machine-learned rotation power model. The motor data is input into the model, which processes it to determine the initial rotation power.

The machine-learned rotation power model may be a neural network model, such as a fully connected neural network model. The input layer of the neural network may comprise a plurality of input neurones, one for each piece of motor data. The neural network may comprise one or more hidden layers, followed by an output layer.

The machine-learned rotation power model may have been trained using a set of training data comprising a plurality of training examples, each comprising a set of motor data and a corresponding ground-truth rotation power. The training data may have been derived from a motor test rig comprising a test motor and a plurality of sensors for determining the motor data (e.g. an ammeter, a voltmeter, a thermometer etc.) and the ground truth rotation power (e.g. a torque sensor, such as a high accuracy torque sensor).

To train the machine-learned rotation power model, training examples are input into the machine-learned rotation power model and processed according to current values of parameters (e.g. weights and biases) of the neural network to generate a candidate rotation power. The candidate rotation power is compared to the ground truth rotation power, for example using a loss/objective function (e.g. an L1 or L2 loss). The parameters of the neural network are updated based on the comparison with the aim of reducing the difference between the candidate rotation power and the ground truth rotation power. The optimisation routine may, for example, be stochastic gradient descent.

At operation 7.3, a gearbox efficiency is determined from the gearbox data using a gearbox efficiency model.

The gearbox efficiency model may be an experimentally determined control surface mapping the gearbox data to a gearbox efficiency. Alternatively, the gearbox efficiency model may be in the form of a look-up table.

In some embodiments, the gearbox efficiency model may be a machine-learned model, such as a neural network. For example, the gearbox efficiency model may be a fully connected neural network, such as the network described in relation to the machine-learned rotation power model.

At operation 7.4, an adjusted rotation power is determined by adjusting the initial rotation power of the motor of the motor based on the gearbox efficiency. The adjusted rotation power may be obtained by multiplying the initial rotation power by the gearbox efficiency.

Operations 7.1 to 7.4 may be performed for each of one or more (e.g. a plurality) of drum rotation speeds to determine a set of rotation power data. The rotation power data may comprise a plurality of drum speed-rotation power pairs.

At operation 7.5, a slump value of the concrete mix in the mixing drum is determined from the load data and the adjusted rotation power using a slump prediction model. In some embodiments, the model may use a set of rotation power data comprising a plurality of drum speed-rotation power pairs.

The slump prediction model may be an experimentally determined control surface mapping the rotation power and properties of the concrete mix (e.g. mass) to a slump value. Alternatively, the slump prediction model may be in the form of a look-up table.

In some embodiments, the slump prediction model may be a machine-learned model, such as a neural network. For example, the gearbox slump prediction may be a fully connected neural network, such as the network described in relation to the machine-learned rotation power model.

In embodiments where a zeroing procedure is used, the method may further comprise adjusting the initial rotation power of the motor based on the empty drum rotation profile prior to input into the slump prediction model.

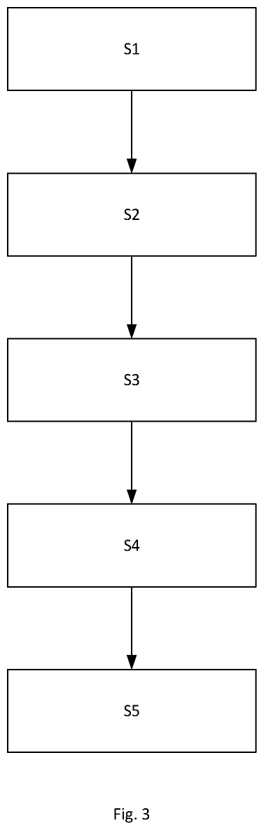

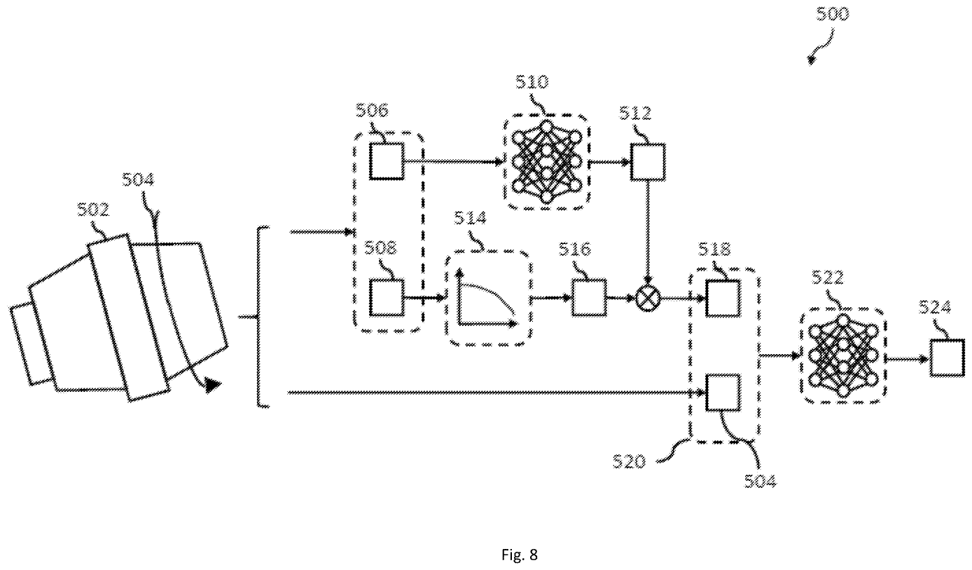

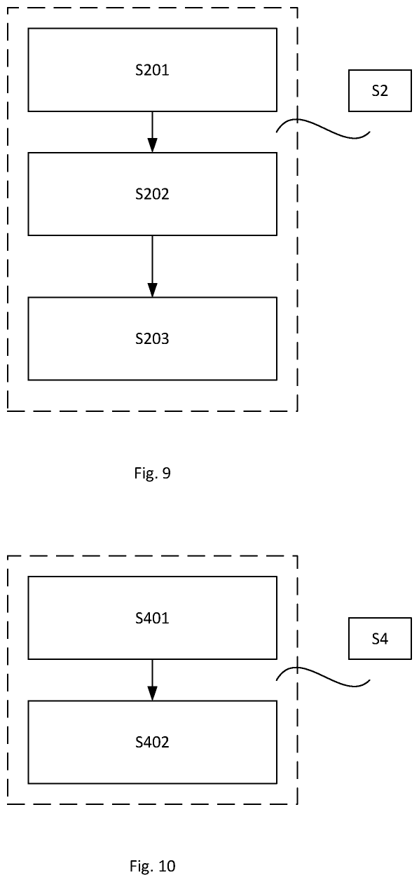

FIG. 8 shows a schematic overview of a method 500 for monitoring a drum 502 of a concrete mixer. The method may be performed by the system used to determine the slump of a concrete mix, and may reuse many of the methods described above in relation to FIGS. 1 to 7.

The drum 502 is emptied of wet concrete, then weighed to obtain an empty drum mass (i.e. the mass of the drum plus the mass of the dried concrete in the drum). Since the distribution of the concrete build-up in the drum important for energy use considerations, the mass of the concrete build-up by itself may not be enough to determine whether the drum requires maintenance.

The drum is then rotated at a plurality of drum rotation speeds 504, which may either be a sequence of steady speeds (for rotation drag calculations) or an acceleration from a low drum speed to a high drum speed (for inertia calculations), during which motor data 506 and gearbox data 508 are collected using the appropriate sensors (as described above in relation to the slump measurement method).

For each rotation speed 504, the motor data 506 is used by a machine-learned rotation power model 510 to determine an initial rotation power 512 for the motor driving the drum and the gearbox data 508 is used by a gearbox model 514 to determine a gearbox efficiency 516, as described above in relation to the slump measurement method. An updated rotation power 518 is obtained by adjusting the initial rotation power 512 based on the determined gearbox efficiency 516, again as described above in relation to the slump measurement method. The result is a set of rotation power data comprising a plurality of rotation speed-rotation power pairs 520.

A build-up model 522 uses the rotation power data 520 to determine a build-up state/build-up data 524 of the concrete mixing drum. The model 522 may, for example be a machine-learned model (i.e. an AI model), as described in more detail below. Alternatively, the model 522 may be a look-up table or control surface curve.

The build-up state/data 524 provides an indication of the amount of build-up in the drum and/r the effects of the build-up. It may, for example, comprise an estimate of the energy consumption. This may be an absolute value or an increase relative to a clean/new drum. Alternatively or additionally, the build-up state/data 524 may comprise a payload reduction when compared to a clean/new drum, i.e. an amount (e.g. mass/volume) of concrete. Alternatively or additionally, the build-up state/data 524 may comprise a rotational drag of the concrete drum or an increase in the rotational drag of the concrete drum when compared to a clean/new drum. Alternatively or additionally, the build-up state/data 524 may comprise a mass of the concrete build-up.

In some implementations, the build-up state 524 may be stored in a memory to maintain a historic record of build-up states. The stored data may be analysed periodically to determine long-term trends.

In some embodiments, a baseline profile corresponding to a clean/new drum may be generated, for example at a factory before the first use of the concrete mixer/drum. The baseline profile may be stored in a memory of a computer system associated with the concrete mixer, e.g. the ECU, and used to make comparisons to the data generated by the build-up model. When determining an initial baseline profile for a mixer/drum, the baseline profile may be compared to baseline profiles of similar mixers (e.g. mixers/drums of the same or equivalent types) to ensure the baseline performance is within tolerance. This scan effectively acts as an additional form of quality control.

The build-up model 522 may be a machine-learned model, such as a neural network. The neural network may be a fully connected neural network, a convolutional neural network or a recurrent neural network (e.g. a long short-term memory network, LSTM). The latter are useful for analysing sequences of data, such as the rotation power data.

The machine-learned build-up model 522 may be trained in a supervised manner on training data comprising rotation power data and corresponding known build-up states/data. The method described in relation to FIG. 7 may be used to train the build-up model.

Once the slump value of the payload 17 (S103c) has been determined, the roll-over warning system 100 may determine the climb of the payload 17 based on CFD models (S103d). In some embodiments, the climb of the payload 17 may be determined by experimental data. For example, experimental data could be collected by locating a mixing drum 16 on a test bed (not shown). The mixing drum 16 could then be filled with various weights of different slumps and rotated at a range of different speeds. Each test could also be carried out at a variety of camber levels. For each combination of slump value, weight of payload 17, and rotational speed, the position of the centre of gravity COG can be measured and, optionally, the change in the centre of gravity between the dead payload position 17A and the live payload position 17B determined. In some embodiments, a combination of experimental data and CFD models could be used.

The climb of the payload 17 upper the inner wall of the mixing drum 16 for an array of slump values at different rotational velocities may be stored on the memory 116 of the roll-over warning system 100. Based on the determined dead payload position 17A, the slump value and the determined rotational velocity of the mixing drum 16, the roll-over warning system 100 may estimate the climb of the payload 17. In some embodiments, the roll-over warning system 100 may extrapolate the climb of the payload 17 based on more than one CFD model that most closely represent the dead payload position 17A, determined slump value, and rotational velocity of the mixing drum 16.

In some embodiments, the climb value determined by the CFD models may be solely based on the rotation of a payload 17 having given dead payload positions 17A and slump values, and may not include changes to the climb of the payload 17 based on centrifugal forces. However, in other embodiments, the climb of the payload 17 may be determined based on the slump value of the payload 17, the rotational velocity of the mixing drum 16, and the centrifugal forces acting on the payload 17.

Once the climb of the payload 17 (S103d) has been determined, the roll-over warning system 100 may determine the live payload position 17B of the centre of gravity COG of the payload 17 based on CFD models (S103e). The live payload position 17B of the payload 17 for an array of climb positions may be stored on the memory 116 of the roll-over warning system 100. Based on the determined climb position, slump value of the payload 17, and weight of the payload 17, the roll-over warning system 100 may determine the live payload position 17B.

Thus, once the centre of gravity of the payload 17 has been determined, the centre of gravity of the vehicle 1 can be determined based on the centre of gravity of the base vehicle 101, the drum assembly 102, and the payload 17.

As mentioned above, the method further comprises the step of determining the forces acting on the vehicle 1 (S2). The step of determining the forces acting on the vehicle 1 may comprise determining the weight of the payload 17 (S201). The weight of the payload 17 may be determined in any of the ways outlined above.

The step of measuring the forces acting on the vehicle (S2) may further comprise determining the weight vector W of the vehicle (S202). Determining the weight vector W of the vehicle 1 (S202) comprises calculating the weight of the vehicle 1, including the base vehicle 101, drum assembly 102, and payload 17 (as described above), and determining the camber and/or roll experienced by the vehicle 1. The weight vector W of the vehicle 1 (S202) is calculated by the processor 114 based on these inputs. A camber sensor 110 may be used to determine the camber of the surface that the vehicle 1 is travelling on. In addition or alternatively, a roll-sensor 110 may be used to determine the roll-angle of the vehicle 1.

The step of determining the forces acting on the vehicle 1 (S2) may comprise receiving, from one or more sensors 110, data comprising at least one of the lateral forces L acting on the drum assembly 102 and the vertical forces V acting on the drum assembly 102 (S203). The lateral forces L may include centrifugal forces. The centrifugal forces arise from the inertia or momentum of the payload 17 when the vehicle 1 is turning. The faster the vehicle 1 is travelling around a corner or the tighter the corner, i.e. the smaller the radius, the larger the centrifugal forces will be. The larger the centrifugal forces, the larger the horizontal component L of a resultant force vector R will be. The size of the horizontal force component L will significantly influence whether the vehicle 1 remains in a stable state or not.

The lateral forces L may additionally include side wind effect. The side wind effect may be measured by a sensor 110, such as, for example, but not limited to a wind angle sensor. The side wind vector, i.e. velocity and direction, may be calculated and the force acting on the vehicle 1 due to side wind determined based on the lateral component of the side wind vector and the known side surface area and profile of the vehicle 1.

The vertical forces V may include any bump forces. Bump forces may be defined as any forces that arise from a heave motion of the vehicle 1 as it travels over bumpy on uneven ground. Specifically, the bump forces may cause an upward force on the payload 17. An upward force on the payload 17 will reduce the downward vertical force component of a resultant force vector R and may heavily influence the direction of the resultant force vector R.

The one or more sensors 110 used to determine the lateral and vertical forces L, V may be located proximate to the centreline of the drum assembly 102. The one or more sensors 110 used to determine the lateral and vertical forces L, V may be located substantially midway along the longitudinal length of the drum assembly 102. The closer the one or more sensors 110 are located to the centre of gravity of the drum assembly 102, the more accurate the measurement of the lateral and vertical forces L, V acting on the centre of gravity of the drum assembly 102 are. Therefore, the one or more lateral and vertical sensors 110 used to determine the lateral and vertical forces L, V at located at or proximate to the centre of gravity of the mixing drum 16.

The one or more sensors 110 may comprise one or more gyroscopes. The one or more sensors 110 may comprise one or more accelerometers. The one or more accelerometers may be configured to measure accelerations in the lateral and/or vertical directions. In some embodiments, the system 100 may comprise a lateral accelerator sensor at the front and rear of the mixing drum 16. In some embodiments, the system 100 comprises a lateral accelerator sensor and a yaw gyroscope to compensate for the rotation of the vehicle 1. The at least one processor 114 can then determine the forces acting on the drum assembly 102 of the vehicle 1 based on the measured accelerations and the determined masses.

In some embodiments, one or more sensors 110 configured to measure the lateral forces acting on the drum assembly 102 may be placed on the frame 14 of the chassis 4 on the centreline Y of the vehicle 1 vertically beneath the centre of gravity of the drum assembly 102. The placement of the one or more sensors 110 may be adjusted based on the shift of the centre of gravity of the drum assembly 102 when a payload 17 is present. In some embodiments, one or more sensors 110 configured to measure the vertical forces V acting on the drum assembly 102 may be placed on the frame 14 of the chassis 4 on the centreline Y of the vehicle 1 vertically above or below the combined centre of gravity of the base vehicle 101 and drum assembly 102. The placement of the one or more sensors 110 may be adjusted based on the shift of the centre of gravity of the vehicle 1 when a payload 17 is present.

As mentioned above, the method further comprises the step of determining the resultant force vector R (S3). The step of determining the resultant force vector R may comprise establishing the resultant force vector R based on the measured lateral forces L, the measured vertical forces V, and the weight vector W of the vehicle 1, including the base vehicle 101, the drum assembly 102 and the payload 17. The resultant force vector R may be determined by summing the lateral force vector L, the vertical force vector V, and the weight vector W. The resultant force vector R will have a magnitude and direction.

Under conditions where the vehicle 1 is travelling in a straight line and the mixing drum 16 is not rotating, it is expected that the resultant force vector R is substantially vertical and acting substantially at the centreline of the vehicle 1. In this example, the vehicle 1 is expected to be stable and furthest from a potential roll-over event.

Under conditions where the vehicle 1 is travelling in a straight line and the mixing drum is rotating, it is expected that the resultant force vector R will have a not larger, horizontal component than the first example because the gravitational forces are still acting vertically. When the mixing drum 16 is rotating, it is expected that the resultant force vector R will act from a point spaced from the centreline Y of the vehicle 1 based on the shift centre of gravity of the payload 17. Although less stable than the first example, in this example the vehicle 1 is still expected to be sufficiently stable to avoid any potential roll-over event. The one exception in this example is when a large camber, or roll angle, or side wind effect is present.

Under conditions where the vehicle 1 is travelling around a bend or corner, it is expected that the resultant force vector R will have a larger horizontal component than the first and second example above. In conditions where the mixing drum 16 of the vehicle 1 is rotating, the resultant force vector R is expected to have an even larger horizontal component. However, the main factor in whether the vehicle 1 will remain stable when the mixing drum 16 is rotating is the shift in the centre of gravity of the vehicle 1. The reason being that the resultant force vector R can be considered to act from the position of the centre of gravity. Therefore, even if the forces acting on two vehicles 1 are substantially the same such that the resultant force vectors R are substantially the same in direction and magnitude, the vehicle 1 having is centre of gravity closer to the centreline Y of the vehicle 1 may remain in a stable state whereas the vehicle 1 having its centre of gravity further from the centreline Y of the vehicle 1 may be in an unstable state and may begin to roll-over. When the vehicle 1 enters an unstable state, the acceleration towards the vehicle 1 overturning begins. If the unstable state is maintained for a long enough time period, a roll-over event will occur.

Once the resultant force vector R has been determined by the roll-over warning system 100, the roll-over warning system 100 must compare the determined centre of gravity of the vehicle 1 and the determined resultant force vector R against known conditions for vehicle roll-over (S4). The step of comparing the determined centre of gravity and resultant force vector R to known conditions for vehicle roll over (S4) may comprise determining known conditions for vehicle roll over by determining a stability vector S between the determined centre of gravity and an end of the wheel track (S401).

In some embodiments, the known conditions for vehicle roll over may be stored on the memory 116 of the roll over warning system 100. The known conditions may be known for plurality of centre of gravity positions of the vehicle 1.

In some embodiments, the known conditions for vehicle roll-over may be determined by the roll-over warning system 100 based on the determined centre of gravity of the vehicle 1 and the known position of an end of the wheel track T. That is, the positions of each end of the wheel track T will be known within the reference frame or coordinate system of the roll-over warning system 100. Furthermore, the determined position of the centre of gravity of the vehicle 1 is known within the same reference frame or coordinate system of the roll-over warning system 100.

Therefore, the roll-over warning system 100 may determine the vector extending between the determined centre of gravity of the vehicle 1 and an end of the wheel track T closest to the centre of gravity of the vehicle 1. The vector extending from the determined centre of gravity of the vehicle 1 and an end of the wheel track T may be known as a stability vector S. The stability vector S is the vector that represents the limit of the stability of the vehicle 1. If the determined resultant force vector R has a direction that extends at an angle that is equal to or less than the direction of the stability vector S with respect to the vertical axis extending downwards from the centre of gravity of the vehicle 1 between the ends of the wheel track T, then the vehicle 1 is in a stable condition.

In some embodiments, the roll-over warning system 100 may determine a vector between the determined centre of gravity of the vehicle 1 and each end of the wheel track T. The stability vectors S extending from the determined centre of gravity of the vehicle to each end of the wheel track T create a stability space. Any resultant vector R with a direction that extends within the stability space between the edges of the wheel track T means that the vehicle 1 is stable and is not in danger of potentially rolling over.

The step of comparing the determined centre of gravity and resultant force vector R to known conditions for vehicle roll over (S4) comprises comparing the direction of the resultant force vector R to the direction of the stability vector S (S402). By comparing the two vectors, the roll-over warning system 100 can determined at that point in time whether the vehicle 1 is stable or unstable.

The system 100 may then perform a step of determining a roll-over indicator value. The roll-over indicator value may be a ratio of the direction of the resultant force vector R to the stability vector S.

The roll-over indicator value may be stored in the memory 116 of the system 100. Each roll-over indicator value for a given time and location can be uploaded to the cloud or downloaded and used to train vehicle operators and to identify risky locations and plan safer transport routes.

In some embodiments, the step of determining the roll-over indicator value may include an additional step. The additional step may include modifying the roll-over indicator value. The roll-over indicator value may be modified by a sensor 110 that determines upcoming or future conditions. The upcoming or future conditions may be related to the upcoming road or surface that the vehicle 1 is travelling on, such as road camber. Additionally or alternatively, the roll-over indicator value may be modified by a sensor 110 that is configured to determine a vehicle parameter, such as roll-rate. That is, the roll-over indicator value may be modified by a sensor 110 that is configured to determine the roll-rate of the vehicle 1. The system 100 may then modify the roll-over indicator value based on the future conditions. A modified roll-over indicator value would provide an operator of the vehicle 1 with more time to correct the velocity of the vehicle 1 in order to avoid a roll-over event.

In some embodiments, the roll-over indicator value may be modified by a sensor 110 that determines the camber of the road in front of the vehicle 1. That is, the vehicle 1 may comprises a camber sensor 110 configured to determine the camber of the upcoming surface on which the vehicle is travelling. For example, if the camber of the upcoming road is larger than the current determined camber of the road, the system 100 may modify the roll-over indicator value by increasing its value to account for the upcoming conditions that would present a greater chance of the vehicle 1 rolling over.

In some embodiments, the system 100 may perform the above mentioned steps with the future condition, i.e. road camber, to determine whether the future condition has a higher or lower roll-over indicator value. If the roll-over indicator value using the future condition, i.e. road camber, is larger than the roll-over indicator value based on the current inputs, then the system 100 may use the modified roll-over indicator value based on the future conditions.

In some embodiments, the roll-over indicator value may be modified by a sensor 110 that determines the roll rate of the vehicle 1. That is, the vehicle 1 may comprise a roll-rate sensor 110 configured to determine the roll-rate of the vehicle 1. The roll-rate sensor 110 may directly measure the roll-rate of the vehicle 1. The roll-rate sensor 110 may store data from a roll sensor 110 of the system 100 and then differentiate the roll values with respect to time to determine the roll-rate.

Thus, if the roll-rate of the vehicle 1 shows that the vehicle 1 is accelerating in roll, the system 100 may modify the roll-over indicator value by increasing the roll-over indicator value. Conversely, if the roll-rate of the vehicle 1 shows that the vehicle 1 is decelerating in roll, the system 100 may modify the roll-over indicator value by decreasing the roll-over indication value.

The roll-over indicator value may be modified in proportion to the roll-rate. In some embodiments, the roll-over indicator value may be modified in linear proportion, such that, for example, but not limited to, a given change in roll-rate results in a change to the roll-over indicator value by a given factor. In some embodiments, the roll over indicator value may be modified in non-linear proportion to the roll-rate such that a larger change in the roll-rate results in a larger change in the roll-over indicator value than a smaller change in the roll rate. For example, in some embodiments, a roll-rate below a predetermined roll rate value may result in a smaller proportional change to the roll-over indicator value than a roll-rate above the predetermined roll rate value.

For example, a roll-rate of less than 0 m/s, i.e. negative roll-rate, may indicate a roll towards a stable, central position and may result in a change of the roll-over indicator factor by a factor of 0.5. Furthermore, a roll-rate below 0.5 deg/s may result in a change of the roll-over indicator by a factor of 1.2 and a roll-rate above 1 deg/s may result in a change of the roll-over indicator value by a factor of 2.

In some embodiments, a predetermined multiplier may be applied. For example, a roll-rate between 0 and 0.5 deg/s may result in the roll-over indicator value being multiplied by 1.1 or 1.2, whereas a roll-rate over 1 deg/s may result in the roll-over indicator value being multiplied by 2. It will be appreciated that the multipliers/factors and the roll-rates to which they applied are given here only as an example and that other values may be used and/or programmed into the system.

Once the step of comparing the determined centre of gravity and resultant force vector R to known conditions for vehicle roll over (S4) has been completed, the roll-over warning system 100 performs the step of indicating to an operator of a vehicle 1 the risk level of a potential roll-over event occurring (S5).

In some embodiments, the step of indicating to an operator of a vehicle 1 the risk of a potential vehicle roll over event occurring comprises continuously providing an indication of the risk of a potential vehicle roll-over event to an operator of a vehicle 1. For example, the risk level may be continuously provided on a scale from 0, representing the lowest chance of a roll-over event occurring, to 100, representing the highest chance of a roll-over event occurring. The top end of the scale, represented by 100, may be either known roll-over conditions or a predetermined threshold. The predetermined threshold represented by the top of the scale may be any of the predetermined thresholds mentioned hereinafter. As a non-limiting example, the predetermined threshold may be when the resultant force vector R is within the wheel track T and within 30 or 10 degrees of known roll-over conditions, or the resultant force vector R is within a distance of 0.5 metres or 10% from the end of the wheel track T. For different vehicles 1 or different loads, the predetermined threshold may be different to the example values given above. In some embodiments, the predetermined threshold may be a ratio of the direction of the resultant force vector to the stability vector of for example, but not limited to, 0.7, 0.8, or 0.9. In some embodiments, the value that indicates a roll-over event or a predetermined threshold may be exceeded by the indicator. That is, for example, but not limited to, where 100 is the top of the scale representing roll-over (or a predefined threshold), the indicator may indicate a value of over 100 to show how severely unstable the vehicle 1 is.

In some embodiments, the step of indicating to an operator of a vehicle 1 the risk level of a potential roll-over event occurring comprises indicating to an operator the risk level of a potential roll-over event occurring when the centre of gravity and the resultant force vector R are within a predetermined threshold of a known roll-over condition. The predetermined threshold of the known roll-over condition may be the known roll-over condition as defined above. That is, the predetermined threshold of the known roll-over condition may be the stability vector S. For example, wherein the step of alerting an operator of a vehicle 1 about a potential vehicle roll over event is performed when the direction of the resultant vector R is in line with the known roll over condition, i.e. the stability vector S. However, in some instances, alerting an operator of a vehicle 1 about a potential roll-over event at this stage may be too late because the inertial forces may be too great for the operator to be able to react quickly enough to prevent the roll-over event.

Therefore, in some embodiments, the step of alerting an operator of a vehicle 1 about a potential vehicle roll over event may be performed when the direction of the resultant vector R is within the wheel track T and within 30 degrees of the known roll over condition. In other embodiment, the direction of the resultant vector may have to be within 20, 15, 10, or 5 degrees of the known roll over condition.

In some embodiments, the step of alerting an operator of a vehicle 1 about a potential vehicle roll over event may be performed when the direction of the resultant vector R is within the wheel track T and within 10 degrees of the known roll over condition.

In some embodiments, the predefined threshold may be defined in terms of the distance between an end of the wheel track T and the point where the resultant force vector R intersects, or would intersect if extrapolated, the plane of the wheel track T. The predefined threshold may be, for example, 0.5 metres or 10% of the wheel track T. However, it will be appreciated that the values given are merely examples and that the predetermined threshold may be any value determined by the vehicle operator or owner.

In some embodiments, the roll-over warning system 100 may alert the operator of a vehicle 1 about a potential vehicle roll over event at a plurality of thresholds, such as those described above. The alert may vary in severity, with the most severe alerts being used when the vehicle 1 is closer to the roll-over condition.

In some embodiments, the predefined threshold may be when no lateral forces L are acting on the drum assembly 102 of the vehicle 1. In this way, the operator of the vehicle 1 will always have some form of alert to inform him of the stability of the vehicle 1.

The step of alerting an operator of a vehicle 1 about a potential vehicle roll over event may be performed visually via a display in a cabin 2 of the vehicle 1. The visual display may be a continuous, real-time display of the stability condition of the vehicle 1, including the modified roll-over indicator value. The visual display may be shown in the form of a bar, which increases and decreases in height or length in dependence of the proximity of the stability of the vehicle 1 to a roll-over event.

With increases and decreases in the height or length of the visual display, the colour of the visual display may change to further indicate the danger of the proximity of the stability of the vehicle 1 to a roll-over event. Either the whole visual display may change colour or sections of the visual display may have set colours such that one colour represents a given proximity of the stability of the vehicle 1 to a roll-over event. For example, a green coloured bar may be shown when the resultant force vector is greater than 30 degrees from the stability vector, a yellow coloured bar may be shown extending from the green bar when the resultant force vector is within 10 to 30 degrees of the stability vector, and a red coloured bar extending from the yellow bar may be shown when the resultant force vector is within 10 degrees of the stability vector. The size of the bar may increase in proportion to the proximity of the stability of the vehicle 1 to the roll-over condition.

In some embodiments, the visual display may be a number read out, such as a percentage or distance, or any type of gauge. In some embodiments, the visual display may always show a number. The number may range between, for example, but not limited to, 0 to 1 (inclusive), or 0 to 100 (inclusive), 0 to 2 (inclusive), or 0 to 150 (inclusive).

Alternatively or additionally, the step of alerting an operator of a vehicle 1 about a potential vehicle roll over event is performed audibly via a speaker in a cabin of the vehicle 1. The speaker may play any noise or voice message.

In some embodiments, the method described above may be caused to repeat by the roll-over warning system 100 whenever the vehicle 1 is running. In some embodiments, the method may be repeated at predetermined time intervals in order to constantly update the operator of a vehicle 1 about the stability state of the vehicle 1. The predetermined time interval may be, for example, but not limited to, every 10 seconds, 5 seconds, 2 seconds, or 1 second, or 0.1 seconds. Especially at higher rates, the data relating to the roll-over indicator value or the stability condition of the vehicle 1 may be filtered or smoothed out before it is indicated to the operator of the vehicle 1. This helps to avoid ‘noise’ generated from the sensors, which is not filtered/smoothed out could create a highly variable display for the operator that would change too much to enable the operator to understand the likelihood of a roll-over event occurring.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description, it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore, in the claims means-plus-function clauses are intended to cover the structures described herein as performing the recited function and not only structural equivalents, but also equivalent structures.

1. A method for alerting an operator of a vehicle about a potential vehicle roll over event, the method comprising:
determining the centre of gravity of a vehicle (S1);
determining the forces acting on the vehicle (S2);
determining the resultant force vector (S3);
comparing the determined centre of gravity and resultant force vector to known conditions for vehicle roll over (S4); and
indicating to an operator of a vehicle the risk of a potential vehicle roll over event occurring (S5).

2. The method according to claim 1, wherein the step of determining the centre of gravity of the vehicle (S1) comprises:
determining the centre of gravity of a base vehicle (S101a) and the centre of gravity of a drum assembly (S101b), and
determining the presence of a payload (S102) and,
if a payload is present, determining the centre of gravity of the payload (S103).

3. The method according to claim 2, wherein determining the presence of the payload (S102) is performed by an input from an operator.

4. The method according to claim 2, wherein determining the presence of the payload (S102) is performed by weighing the drum assembly and calculating the difference between the measured weight and the drum assembly empty weight.

5. The method according to any one of claim 2 to claim 4, wherein determining the centre of gravity of the payload (S103) comprises:
determining a dead payload position of the centre of gravity of the payload; and
determining the rotational velocity of a mixing drum of the drum assembly.

6. The method according to claim 5, wherein if it is determined that the mixing drum has a rotational velocity greater than zero, the step of determining the centre of gravity of the payload comprises:
determining the slump value of the payload (S103c);
determining the climb of the payload based on CFD models (S103d); and
determining the live load position of the centre of gravity of the payload based on CFD models (S103e).

7. The method according to claim 6, wherein the step of determining the slump value of the payload is performed by an input from an operator.

8. The method according to claim 6, wherein the step of determining the slump value of the payload comprises:
receiving, from one or more sensors, motor data comprising a state of a motor driving the mixing drum, gearbox data comprising a state of a gearbox arranged between the motor and the mixing drum, and payload data relating to a mass of the payload in the mixing drum (7.1);
determining, by a machine-learned rotation power model, an initial rotation power of the motor from the motor data (7.2);
determining, by a gearbox efficiency model, a gearbox efficiency from the gearbox data (7.3);
determining an adjusted rotation power by adjusting the initial rotation power of the motor of the motor based on the gearbox efficiency (7.4); and
determining, by a slump prediction model, an estimate slump value of the concrete mix in the mixing drum from the payload data and the adjusted rotation power (7.5).

9. The method according to any one of the preceding claims, wherein the step of determining the forces acting on the vehicle (S2) comprises:
determining the weight of the payload (S201);
determining the weight vector of the vehicle (S202); and
receiving, from one or more sensors, data comprising at least one of the lateral forces and the vertical forces acting on the drum assembly (S203).

10. The method according to claim 9, wherein the one or more sensors comprise one or more gyroscopes located proximate to the centreline of the drum assembly and substantially midway along the longitudinal length of the drum assembly.

11. The method according to anyone of the preceding claims; wherein the step of determining the resultant force vector (S3) comprises establishing the resultant force vector based on the measured lateral forces, the measured vertical forces and the weight vector of the vehicle.

12. The method according to anyone of the preceding claims, wherein the step of comparing the determined centre of gravity and resultant force vector to known conditions for vehicle roll over (S4) comprises:
determining known conditions for vehicle roll over by determining a stability vector between the determined centre of gravity and an end of the wheel track (S401); and
comparing the direction of the resultant force vector to the direction of the stability vector (S402).

13. The method according to claim 12, wherein the step of comparing the direction of the resultant force vector to the direction of the stability vector comprises the step of determining a roll-over indicator value.

14. The method according to claim 13, wherein the step of determining a roll-over indicator value comprises determining a ratio of the direction of the resultant force vector to the stability vector.

15. The method according to claim 14, wherein the roll-over indicator value is modified based on a sensor configured to determine a future condition.

16. The method according to claim 14 or claim 15, wherein the roll-over indicator value is modified based on a sensor configured to determine the roll-rate of the vehicle.

17. The method according to any one of the preceding claims, wherein the step of indicating to an operator of a vehicle the risk of a potential vehicle roll over event occurring comprises continuously providing an indication of the risk of a potential vehicle roll-over event to an operator of a vehicle.

18. The method according to claim 17, wherein continuously providing an indication of the risk of a potential vehicle roll-over event to an operator of a vehicle is performed by showing a visual representation of a roll-over indicator value.

19. The method according to any one of the preceding claims, wherein the step of indicating to an operator of a vehicle the risk of a potential vehicle roll over event occurring is performed visually via a display in a cabin of the vehicle.

20. The method according to any one of the preceding claims, wherein the step of indicating to an operator of a vehicle the risk of a potential vehicle roll over event occurring is performed audibly via a speaker in a cabin of the vehicle.

21. The method according to any one of the preceding claims, wherein the step of indicating to an operator of a vehicle the risk of a potential vehicle roll over event occurring comprises alerting an operator of a vehicle about a potential vehicle roll over event is performed when the direction of the resultant vector is within the wheel track and within 30 degrees of the known roll over condition.

22. The method according to any one of the preceding claims, wherein the step of indicating to an operator of a vehicle the risk of a potential vehicle roll over event occurring comprises alerting an operator of a vehicle about a potential vehicle roll over event is performed when the direction of the resultant vector is within the wheel track and within 10 degrees of the known roll over condition.

23. The method according to any one of the preceding claims, wherein the step of indicating to an operator of a vehicle the risk of a potential vehicle roll over event occurring comprises alerting an operator of a vehicle about a potential vehicle roll over event is performed when the direction of the resultant vector is in line with the known roll over condition.

24. A roll-over warning system comprising:
a vehicle comprising a base vehicle and a drum assembly;
one or more sensors;
one or more processors;
a memory;
wherein the system is configured to perform the method of any one of the preceding claims.

25. A vehicle comprising the roll-over warning system of claim 24, and optionally, wherein the vehicle is a concreter mixer.
